(19) United States
(12) Patent Application Publication
(10) Pub. No.: US 2026/0303349 A1
(43) Pub. Date: Oct. 1, 2026

(54) SYSTEM FOR EDGE COMPUTING AND METHOD OF OPERATING THE SAME

(71) Applicant: Korea Advanced Institute of Science and Technology, Daejeon (KR)

(72) Inventors: Dongsu Han, Daejeon (KR); Jinwoo Park, Daejeon (KR); Seunggeun Cho, Daejeon (KR)

(73) Assignee: Korea Advanced Institute of Science and Technology, Daejeon (KR)

(21) Appl. No.: 19/334,110

(22) Filed: Sep. 19, 2025

(30) Foreign Application Priority Data
Mar. 31, 2025 (KR) 10-2025-0041663

(51) Int. Cl. H04L 9/32

(52) U.S. Cl. CPC H04L 9/3213

(57) ABSTRACT

The inventive step relates to a system for edge computing with improve token processing efficiency and includes an edge device configured to generate candidate tokens in response to a user input and to generate proactive tokens while the candidate tokens are verified, and a server configured to verify the candidate tokens received from the edge device and to transmit to the edge device whether to accept the candidate tokens.

### CROSS-REFERENCE TO RELATED APPLICATION(S)

This application claims priority under 35 U.S.C. § 119 to Korean Patent Application No. 10-2025-0041663, filed on Mar. 31, 2025, which is hereby incorporated by reference for all purposes as if fully set forth herein.

### BACKGROUND

### 1. Field

Embodiments relate to a system for edge computing and method of operating the same. More particularly, embodiments relate to the system for edge computing for providing a large language model inference and the method of operating the same.

### 2. Description of the Related Art

With an advancement of artificial intelligence (AI) technology, AI services utilizing such technology are becoming increasingly widespread. In particular, AI services based on large language model (LLM), which infers and processes language, are gaining significant attention.

Recently, speculative decoding technique is being studied to reduce a high inference latency of the LLM. The speculative decoding generates tokens as a draft and then verifies the tokens in parallel. However, performing both draft generation and verification in a single device presents a challenge due to the considerable cost involved.

### SUMMARY

Embodiments provide a system for edge computing with improved token processing efficiency.

Embodiments provide a method of operating the system for edge computing.

A system for edge computing according to an embodiment includes an edge device configured to generate candidate tokens in response to a user input and a server configured to verify the candidate tokens received from the edge device,

In an embodiment, the edge device may be configured to generate proactive tokens extending from a node located at a final order of the candidate tokens while the candidate tokens are being verified.

In an embodiment, the server may be configured to transmit to the edge device whether to accept the candidate tokens.

In an embodiment, the server may be configured to determine whether to accept the candidate tokens.

In an embodiment, when the server accepts all of the candidate tokens, the server may be configured to generate a bonus token extending from the node located at the final order of the candidate tokens.

In an embodiment, the server may be configured to determine whether the bonus token matches a token located at a first node of the proactive tokens.

In an embodiment, when the server accepts all of the candidate tokens and the bonus token matches the token located at the first node of the proactive tokens, the edge device may be configured to generate next candidate tokens extending from the proactive tokens by using the proactive tokens.

In an embodiment, the edge device may be configured to adjust parameters to maximize an expected gain according to the following an [equation 1] based on a verification result from the server.

$$𝔼 ( Gain ) = {P}_{align} \cdot {P}_{match \vert align} \cdot ( \frac{{T}_{draft}}{{H}_{expan}} - 1 ) \qquad [ equation 1 ]$$

Here, [symbol] (Gain) may be the expected gain, P_{align} may be a probability that the candidate tokens are accepted by the server, P_{match|align} may be a conditional probability that the bonus token matches the token located at the first node of the proactive tokens when the candidate tokens are accepted by the server, T_{draft} may be a total number of nodes corresponding to the proactive tokens, and Hₑₓₚₐₙ may be a number of nodes corresponding to the token located at the first node of the proactive tokens.

A method of operating the system for edge computing according to an embodiment includes verifying candidate tokens generated in response to a user input, generating proactive tokens extending from a node located at the final order of the candidate tokens while the candidate tokens are verified, and determining whether to accept the candidate tokens and generating next candidate tokens.

In an embodiment, the generating the next candidate tokens may include determining whether a bonus token matches a token located at a first node of the proactive tokens.

In an embodiment, in the determining whether to accept the candidate tokens, when all of the candidate tokens are accepted, the determining whether the bonus token matches the token located at the first node of the proactive tokens may be performed.

In an embodiment, when the bonus token matches the token located at the first node of the proactive tokens, the next candidate tokens extending from the proactive tokens may be generated.

In an embodiment, wherein in the determining whether to accept the candidate tokens, when a portion of the candidate tokens is accepted, the next candidate tokens connected to the portion of the candidate tokens, which is accepted, may be generated.

In an embodiment, wherein in the determining whether to accept the candidate tokens, when none of the candidate tokens is accepted, all of the candidate tokens may be discarded.

In an embodiment, the method may further include performing an operation according to token verification requests simultaneously by determining a batch size of the token verification requests of users which are waiting.

In an embodiment, the batch size may increase as a number of nodes in the token verification requests increases.

In an embodiment, wherein when the candidate tokens proceed to the next path, the candidate tokens may be extended in a tree form in which multiple paths are generated.

In an embodiment, when the candidate tokens proceed to the next path, the candidate tokens may be sequentially extended through one optimal path

A method of operating the system for edge computing according to an embodiment includes generating candidate tokens in an edge device in response to a user input and receiving the candidate tokens from the edge device and verifying the candidate tokens in a server.

In a system for edge computing according to embodiments of the present inventive step, an edge device performs a task of generating tokens, and a server performs a task of verifying the tokens. Accordingly, since the server does not perform both generation and verification of the tokens and the edge device and the server share tasks, token processing efficiency may be improved.

In a method of operating the system for edge computing according to embodiments of the present inventive step, while the server performs verification of candidate tokens, the edge device may pre-generate proactive tokens to be connected after the candidate tokens, so that a number of communications between each of edge devices and the server may be reduced, thereby reducing idle time.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a system for edge computing according to an embodiment of the present inventive step.

FIG. 2 is a flowchart illustrating an example of a method of operating the system for edge computing of FIG. 1.

FIG. 3 is a block diagram for explaining of method of operating the system for edge computing of FIG. 2.

FIGS. 4A and 4B are drawings for explaining a generating of proactive tokens while verifying candidate tokens in FIG. 2.

FIGS. 5A and 5B are drawings for explaining a determining of whether to accept candidate tokens based on a verification result in FIG. 2.

FIG. 6 is a flowchart illustrating another example of a method of operating the system for edge computing of FIG. 1.

### DETAILED DESCRIPTION OF THE EMBODIMENTS

In the embodiments of the present inventive step disclosed herein, specific structural or functional descriptions are merely illustrated for the purpose of describing embodiments of the inventive step, and the embodiments of the inventive step may be implemented in various forms and should not be construed as being limited to those described herein.

The present inventive step may undergo various modifications and may take on various forms. Specific embodiments are illustrated in the drawings and described in detail in the text. However, this is not intended to limit the present inventive step to the specific disclosed forms, but rather should be understood to include all modifications, equivalents, and alternatives falling within the spirit and scope of the present inventive step.

Terms such as “first”, “second”, and the like may be used to describe various components, but the components are not limited by these terms. These terms may merely be used to distinguish one component from another. For example, a first component may be referred to as a second component without departing from the scope of the present inventive step, and similarly, a second component may be referred to as a first component.

When a component is said to be “connected” or “coupled” to another component, it may be understood that it can be directly connected or coupled to the other component, or that there may be one or more intervening components between them. In contrast, when a component is said to be “directly connected” or “directly coupled” to another component, it should be understood that there are no intervening components. Other expressions describing the relationship between components, such as “between ~” and “directly between ~”, or “adjacent to ~” and “directly adjacent to ~”, should be interpreted in the same manner.

The terminology used in the present application is merely for the purpose of describing particular embodiments and is not intended to limit the present inventive step. The singular forms are intended to include the plural forms as well, unless the context clearly indicates otherwise. As used in this application, the terms “comprise”, “include”, “have”, and the like are intended to specify the presence of stated features, numbers, steps, operations, components, parts, or combinations thereof, but do not preclude the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which the present inventive step pertains. Terms generally defined in dictionaries should be interpreted as having a meaning consistent with their use in the relevant technical field and should not be interpreted in an idealized or overly formal sense unless explicitly defined herein.

In addition, where a particular function or operation is described in a block of a flowchart, it may be performed in a different order than as described in the flowchart, if the embodiment allows for alternative implementations. For example, two consecutive blocks may actually be executed substantially simultaneously, or the blocks may be executed in reverse order depending on the relevant functions or operations.

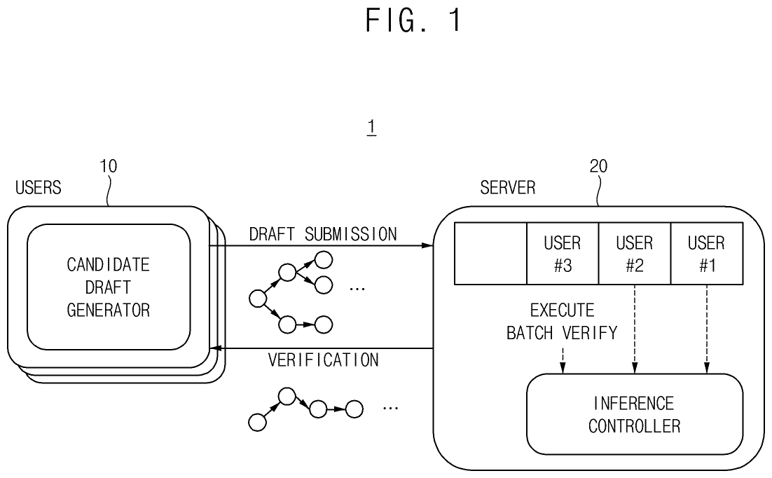

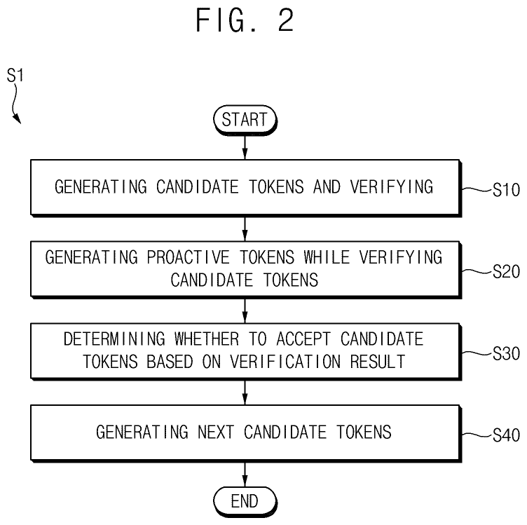

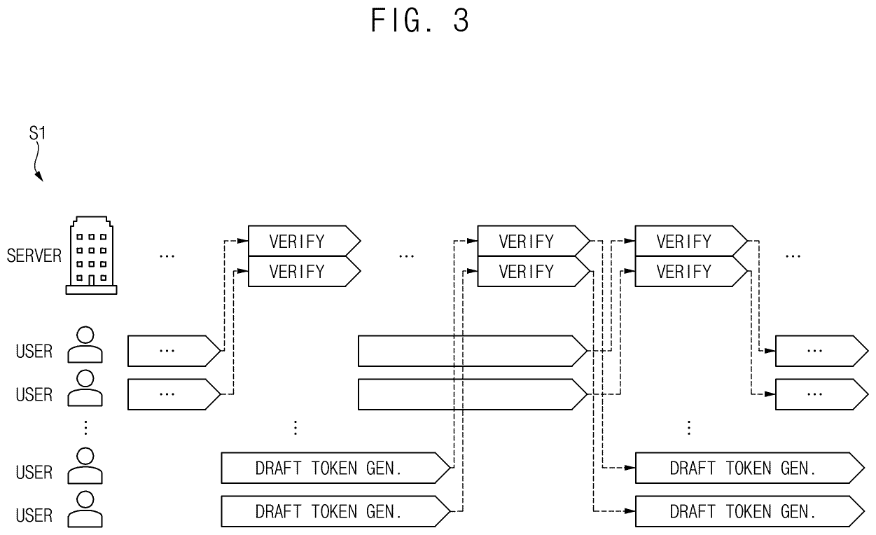

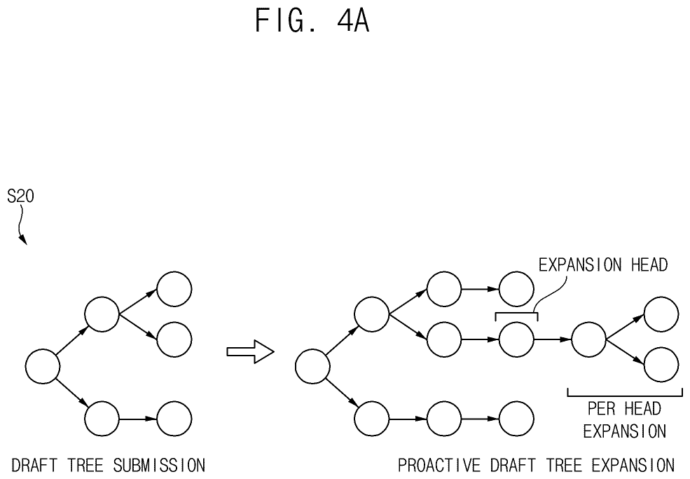

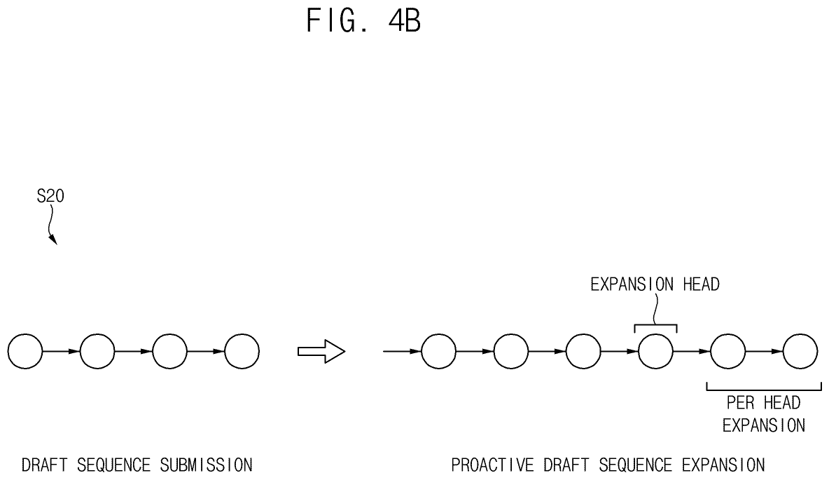

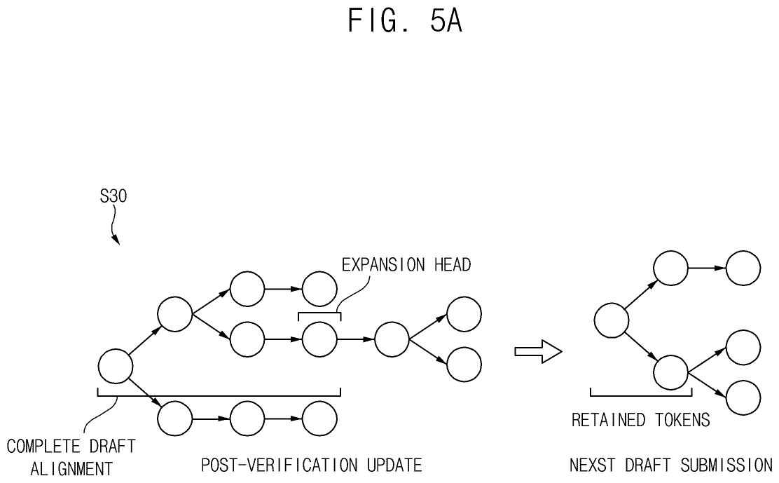

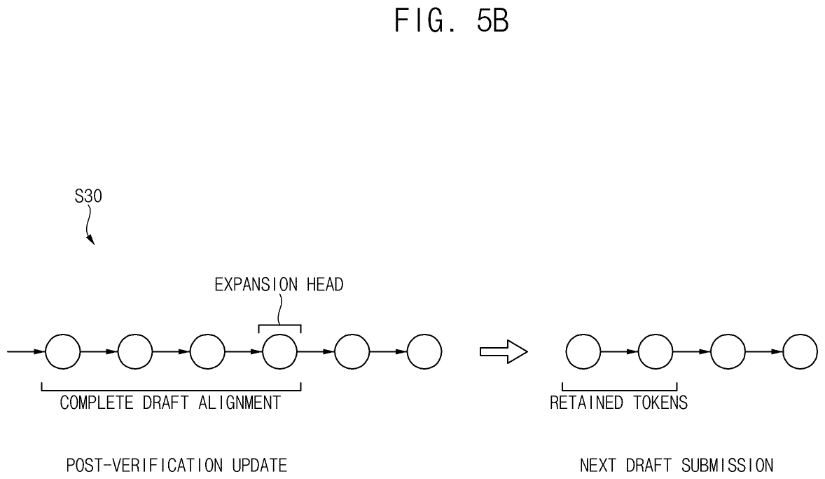

FIG. 1 is a block diagram illustrating a system for edge computing according to an embodiment of the present inventive step. FIG. 2 is a flowchart illustrating an example of a method of operating the system for edge computing of FIG. 1. FIG. 3 is a block diagram for explaining of method of operating the system for edge computing of FIG. 2. FIGS. 4A and 4B are drawings for explaining a generating of proactive tokens while verifying candidate tokens in FIG. 2. FIGS. 5A and 5B are drawings for explaining a determining of whether to accept candidate tokens based on a verification result in FIG. 2.

For example, FIG. 4A is a drawing for explaining an example of the generating of proactive tokens while verifying candidate tokens in FIG. 2, and FIG. 4B is a drawing for explaining another example of the generating of proactive tokens while verifying candidate tokens in FIG. 2. FIG. 5A is a drawing for explaining an example of the determining of whether to accept candidate tokens based on a verification result in FIG. 2, and FIG. 5B is a drawing for explaining another example of the determining of whether to accept candidate tokens based on a verification result in FIG. 2

Referring to FIGS. 1, 2, 3, 4A, 4B, 5A and 5B, a system for edge computing 1 may include an artificial intelligence neural network mode which generates a result corresponding to an user input, and learns a process for generating the result. For example, the artificial intelligence neural network model may be a model based on a large language model, LLM. However, a type of artificial intelligence neural network model on which the system for edge computing 1 according to embodiments of the present inventive step is based may not be limited thereto.

The system for edge computing 1 may include edge devices 10 and a server 20. The edge devices 10 may be fixed terminals or mobile terminals used by users and implemented as computer systems. For example, the edge devices 10 may be a smart phone, mobile phone, navigation device, computer, laptop, digital broadcasting terminal, personal digital assistant (PDA), portable multimedia player (PMP), tablet PC, game console, wearable device, internet of things (IoT) device, virtual reality (VR) device, augmented reality (AR) device, and the like. In other words, the edge devices 10 may be various physical computer systems that may communicate with the server 20 through a network using wireless or wired communication methods. In the inventive step, the edge devices 10 may be used in singular or plural form, and their function or role does not vary depending on the form.

The server 20 may be implemented as a computer device or a plurality of computer devices that communicate with each of the edge devices 10 through the network and provide commands, codes, files, content, services, and the like. For example, the server 20 may be a system that provides services to each of the edge devices 10 connected through the network. Specifically, the server 20 may be a computer program installed and executed on each of the edge devices 10 and may provide services (e.g., a data provision) intended by an application to each of the edge devices 10 through the application or distribute files for installing and executing the application and provide services corresponding to input data of the user.

In an embodiment, the system for edge computing 1 may process and learn from user input based on a speculative decoding. For example, each of the edge devices 10 may generate tokens corresponding to user input. In addition, the server 20 may verify the tokens generated from each of the edge devices 10. Specifically, in the system for edge computing 1, a draft model that generates the tokens and a main model that verifies the draft tokens may not be included in a same computing device. In other words, the draft model and the main model may be physically separated. Here, the tokens may be generated according to user input and may be a basic unit for a language model to understand and generate text.

A method S1 of operating of the system for edge computing 1 according to an embodiment of the present inventive step may include generating candidate tokens and verifying S10, generating proactive tokens while verifying the candidate tokens S20, determining whether to accept the candidate tokens based on the verification result S30, and generating next candidate tokens S40.

In method S1 of operating of the system for edge computing 1, a task of generating tokens from each of the edge devices 10 and requesting verification from the server 20 may be repeated. A final result in response to the request of the user may be output by repeating the generation of token and the verification.

In the generating of the candidate tokens and verifying S10, each of the edge devices 10 may generate the candidate tokens that require verification by the server 20 according to the input of the user. For example, each of the edge devices 10 may generate the candidate tokens corresponding to the input of the user and transmit the candidate tokens to the server 20.

In an embodiment, a form of the candidate tokens may be a tree in which a plurality of nodes forms at least one path. The tree may include a data about types of the generated candidate tokens and a connection order of the candidate tokens. The server 20 may receive the tree from each of the edge devices 10 and verify the candidate tokens from the tree.

In an embodiment, when the candidate tokens proceed to the next path, the candidate tokens may be extended in a tree form in which multiple paths are generated. In another embodiment, when the candidate tokens proceed to the next path, the candidate tokens may be sequentially extended through one optimal path.

In the generating of the proactive tokens while verifying the candidate tokens S20, each of the edge devices 10 may generate the proactive tokens after transmitting the candidate tokens to the server 20. The proactive tokens may be tokens which are not transmitted to the server 20. In addition, the proactive tokens may be tokens pre-generated by each of the edge devices 10 while the candidate tokens are verified by the server 20. The proactive tokens may also be referred to as preliminary tokens.

The proactive tokens may be extended from the node (or token) located at a final order of the candidate tokens. Specifically, the node where the proactive tokens initially connected to final candidate tokens are located may be referred to as an expansion head. That is, a token of the expansion head may be a token located at a first node of the proactive tokens. The proactive tokens may include tokens located at the expansion head and tokens extended from the expansion head.

In an embodiment, the expansion head may be one selected token from among a plurality of tokens initially connected to the generated tokens located at the final order among the candidate tokens. In another embodiment, the expansion head may be one token initially connected to one generated candidate token located at the final order.

In an embodiment, a form of the proactive tokens may be a tree in which a plurality of nodes forms at least one path. The tree may include a data about types of the generated proactive tokens and a connection order of the proactive tokens.

In the determining of whether to accept the candidate tokens based on the verification result S30, the server 20 may verify the candidate tokens and transmit the verification result to each of the edge devices 10. The verification result may include a data about the tokens to be accepted among the candidate tokens, a data about the tokens to be discarded, and a data about a bonus token extending from the node at the end of the candidate tokens. For example, the bonus token may correspond to tokens located at the expansion head.

When the server 20 accepts all of the candidate tokens, the server 20 may generate the bonus token. A case in which the server 20 accepts all of the candidate tokens may mean that the server 20 verifies a type of the candidate tokens and a connection order of the candidate tokens in the tree and accepts both, and the server 20 accepts all of the type of the candidate tokens and the connection order of the candidate tokens.

Specifically, when the server 20 accepts all of the candidate tokens and the bonus token matches the expansion head, each of the edge devices 10 may repeat a task of generating the tokens using the candidate tokens and the proactive tokens generated prior to the verification. A case in which the server 20 accepts all of the candidate tokens and the bonus token of the server 20 matches the expansion head of each of the edge devices 10 may be referred to as a complete draft alignment.

In addition, when the server 20 does not accept at least one token among the candidate tokens, each of the edge devices 10 that received the verification result may discard all the candidate tokens and the proactive tokens.

Further, when the server 20 accepts all of the candidate tokens but the bonus token does not match the expansion head, each of the edge devices 10 that received the verification result may discard all of the proactive tokens.

In an embodiment, each of the edge devices 10 may adjust parameters so that an expected gain according to the verification result is maximized. The expected gain resulting from a generation of the proactive tokens may be defined according to [equation 1] below.

$$𝔼 ( Gain ) = {P}_{align} \cdot {P}_{match \vert align} \cdot ( \frac{{T}_{draft}}{{H}_{expan}} - 1 ) \qquad [ equation 1 ]$$

Here, [symbol] (Gain) is the expected gain, P_{align} is a probability that the candidate tokens are accepted by the server 20, P_{match|align} is a conditional probability that the bonus token matches the token located at the first node of the proactive tokens when the candidate tokens are accepted by the server 20, T_{draft} is a total number of nodes corresponding to the proactive tokens, and Hₑₓₚₐₙ is a number of nodes corresponding to the token located at the first node of the proactive tokens.

A value of the expected gain may increase when the candidate tokens are accepted and the bonus token matches the expansion head. In addition, the value of the expected gain may increase as a ratio of the total number of nodes corresponding to the proactive tokens to the number of nodes corresponding to the expansion head increases. As the value of the expected gain increases, a number of accepted proactive tokens may increase, so that the verification process of the server 20 may be minimized.

In the generating of the next candidate tokens S40, when the server 20 accepts all of the candidate tokens and the bonus token matches the expansion head, each of the edge devices 10 which receives the verification result may generate the next candidate tokens using the proactive tokens which are previously generated. The next candidate tokens may be transmitted to the server 20, and each of the edge devices 10 may generate proactive tokens about the next candidate tokens.

In addition, when the server 20 does not accept at least one of the candidate tokens, the server 20 may generate next tokens connected to foremost tokens among tokens accepted. If the server 20 does not accept all of the candidate tokens, the server 20 may discard all of the candidate tokens and generate new tokens which are the next tokens.

In addition, when the server 20 accepts all of the candidate tokens and the bonus token does not match the expansion head, the server 20 may generate next tokens connected to rearmost tokens among the tokens accepted.

As a process of generating the next tokens, verifying, and generating the proactive tokens is repeated, a final result corresponding to the user's request may be output.

As described above, in the system for edge computing 1 according to embodiments of the present inventive step, the task of generating tokens may be performed by the edge device 10, and the task of verifying tokens may be performed by the server 20. Accordingly, since the server 20 does not perform both the generation and verification of tokens, and the tasks are divided between the edge device 10 and the server 20, the efficiency of token processing may be improved.

As described above, in the operation method S1 of the system for edge computing 1 according to embodiments of the present inventive step, while the server 20 performs verification of the candidate tokens, the edge device 10 may pre-generate the proactive tokens to be connected to the candidate tokens. As a result, a number of communications between each of the edge devices 10 and the server 20 may be reduced, thereby reducing an idle time.

Therefore, an efficient learning and generation process using the system for edge computing 1 and the method S1 of operating the system for edge computing 1 may be provided to the user.

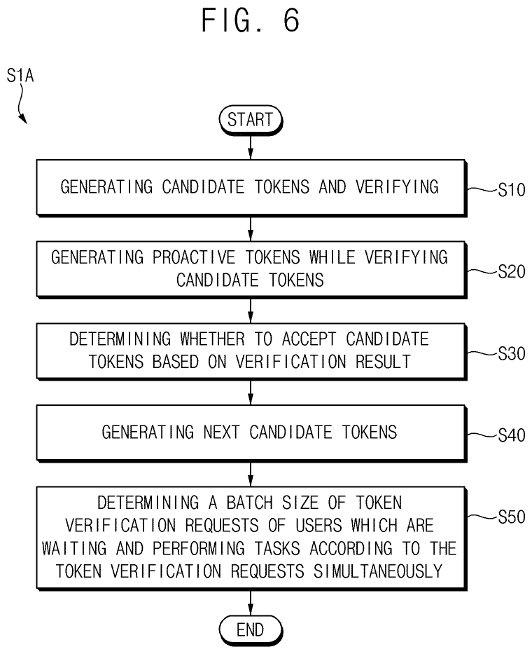

FIG. 6 is a flowchart illustrating another example of a method of operating the system for edge computing of FIG. 1.

A method S1 of operating x described with reference to FIG. 6 may be substantially identical or similar to the operation method S1 described with reference to FIGS. 1, 2, 3, 4, and 5, except that the method SIA further includes a determining a batch size of token verification requests from users which are waiting, and simultaneously performing a task according to the token verification requests S50.

Hereinafter, descriptions that overlap with the content described with reference to FIGS. 1, 2, 3, 4, and 5 may be omitted or briefly explained.

Referring to FIG. 6, the method SIA of operating the system for edge computing may further include the determining the batch size of token verification requests from users which are waiting and simultaneously performing the task according to the token verification requests S50. In an embodiment, the determining of the batch size of token verification requests from users which are waiting and simultaneously performing the task according to the token verification requests S50 may be performed before the generating of the candidate tokens and verifying S10, or may be performed after the generating of the next candidate tokens S40. In other words, the determining of the batch size of token verification requests from users which are waiting and simultaneously performing the task according to the token verification requests S50 may be performed when the server 20 receives and processes the candidate tokens which are waiting.

In the determining of the batch size of token verification requests from users which are waiting and simultaneously performing the task according to the token verification requests S50, while the server 20 is verifying the candidate tokens, verification requests of another candidate tokens from the edge devices 10 may arrive at the server 20. After the verification is completed, the server 20 may adjust the batch size by determining the batch size of the another candidate tokens. For example, as a number of nodes in the token verification requests is greater, the batch size may be larger.

The server 20 may process the token verification requests at once and transmit a verification result to each of the edge devices 10 corresponding to the token verification requests. Accordingly, by processing a plurality of token verification requests in batch at once rather than one by one, the server 20 may reduce a number of communications with the edge devices 10. Therefore, an efficient learning and generation process may be provided to the user by utilizing the method SIA of operating the system for edge computing.

In an embodiment, the determining of the batch size of token verification requests from users which are waiting and simultaneously performing tasks according to the token verification requests S50 may be performed based on an attention masking technique that attends to a valid token. In an embodiment, the determining of the batch size of token verification requests from users which are waiting and simultaneously performing tasks according to the token verification requests S50 may be performed based on a key value cache padding technique that pads the key value cache (KV cache) to match a longest sequence among the token verification requests. However, a technique used in the determining of the batch size of token verification requests from users which are waiting and simultaneously performing tasks according to the token verification requests S50 according to embodiments of the present inventive step may not be limited thereto

The system for edge computing and its operation method according to embodiments of the present inventive step may be implemented as a program, or an application, including an algorithm executable by a computer. The program may be stored and provided in a non-transitory computer-readable medium.

A non-transitory computer-readable medium refers to a medium that stores data semi-permanently and is readable by a device, as opposed to a medium such as a register, cache, or memory that stores data momentarily. Specifically, the various applications or programs described above may be stored and provided in non-transitory computer-readable media such as CD, DVD, hard disk, Blu-ray disc, USB, memory card, read-only memory ROM, programmable ROM PROM, erasable PROM EPROM, electrically erasable PROM EEPROM, or flash memory.

A transitory computer-readable medium refers to various types of RAM, including a static RAM (SRAM), a dynamic RAM (DRAM), a synchronous DRAM (SDRAM), a double data rate SDRAM (DDR SDRAM), an enhanced SDRAM (ESDRAM), a Synclink DRAM (SLDRAM), and a direct Rambus RAM (DRRAM).

The embodiments and drawings attached to this inventive step merely illustrate a portion of the technical concept included in the above-described technology, and modifications and specific embodiments easily inferred by those skilled in the art within the scope of the technical concept described in this specification and drawings shall be included within the scope of rights of the above-described technology is apparent.

What is claimed is:

1. A system for edge computing, the system comprising:
an edge device configured to generate candidate tokens in response to a user input; and
a server configured to verify the candidate tokens received from the edge device.

2. The system for edge computing of claim 1, wherein the edge device is configured to generate proactive tokens extending from a node located at a final order of the candidate tokens while the candidate tokens are being verified.

3. The system for edge computing of claim 2, wherein the server is configured to transmit to the edge device whether to accept the candidate tokens.

4. The system for edge computing of claim 3, wherein the server is configured to determine whether to accept the candidate tokens.

5. The system for edge computing of claim 4, wherein when the server accepts all of the candidate tokens, the server is configured to generate a bonus token extending from the node located at the final order of the candidate tokens.

6. The system for edge computing of claim 5, wherein the server is configured to determine whether the bonus token matches a token located at a first node of the proactive tokens.

7. The system for edge computing of claim 5, wherein when the server accepts all of the candidate tokens and the bonus token matches the token located at the first node of the proactive tokens, the edge device is configured to generate next candidate tokens extending from the proactive tokens by using the proactive tokens.

8. The system for edge computing of claim 5, wherein the edge device is configured to adjust parameters to maximize an expected gain according to the following an [equation 1] based on a verification result from the server
$$𝔼 ( Gain ) = {P}_{align} \cdot {P}_{match \vert align} \cdot ( \frac{{T}_{draft}}{{H}_{expan}} - 1 ) , \qquad [ equation 1 ]$$
here, [symbol] (Gain) is the expected gain, P_{align} is a probability that the candidate tokens are accepted by the server, P_{match|align} is a conditional probability that the bonus token matches the token located at the first node of the proactive tokens when the candidate tokens are accepted by the server, T_{draft} is a total number of nodes corresponding to the proactive tokens, and Hₑₓₚₐₙ is a number of nodes corresponding to the token located at the first node of the proactive tokens.

9. A method of operating a system for edge computing, the method comprising:
verifying candidate tokens generated in response to a user input;
generating proactive tokens extending from a node located at a final order of the candidate tokens while the candidate tokens are verified; and
determining whether to accept the candidate tokens and generating next candidate tokens.

10. The method of claim 9, wherein the generating the next candidate tokens includes:
determining whether a bonus token matches a token located at a first node of the proactive tokens.

11. The method of claim 10, wherein, in the determining whether to accept the candidate tokens,
when all of the candidate tokens are accepted, the determining whether the bonus token matches the token located at the first node of the proactive tokens is performed.

12. The method of claim 11, wherein when the bonus token matches the token located at the first node of the proactive tokens, the next candidate tokens extending from the proactive tokens are generated.

13. The method of claim 10, wherein, in the determining whether to accept the candidate tokens,
when a portion of the candidate tokens is accepted, the next candidate tokens connected to the portion of the candidate tokens, which is accepted, are generated.

14. The method of claim 10, wherein, in the determining whether to accept the candidate tokens,
when none of the candidate tokens is accepted, all of the candidate tokens are discarded.

15. The method of claim 9, further comprising:
performing an operation according to token verification requests simultaneously by determining a batch size of the token verification requests of users which are waiting.

16. The method of claim 15, wherein the batch size increases as a number of nodes in the token verification requests increases.

17. The method of claim 9, wherein when the candidate tokens proceed to the next path, the candidate tokens are extended in a tree form in which multiple paths are generated.

18. The method of claim 9, wherein when the candidate tokens proceed to the next path, the candidate tokens are sequentially extended through one optimal path.

19. A method of operating a system for edge computing, the method comprising:
generating candidate tokens in an edge device in response to a user input; and
receiving the candidate tokens from the edge device and verifying the candidate tokens in a server.
